(19) United States
(12) Patent Application Publication
(10) Pub. No.: US 2024/0416300 A1
(43) Pub. Date: Dec. 19, 2024

(54) HIGH-SPEED CONTINUOUS MIXING APPARATUS

(71) Applicant: Lico S.r.l., Arcisate (VA) (IT)

(72) Inventor: Franco Lico, Cuasso al Monte (VA) (IT)

(73) Assignee: Lico S.r.l., Arcisate (VA) (IT)

(21) Appl. No.: 18/742,567

(22) Filed: Jun. 13, 2024

(30) Foreign Application Priority Data
Jun. 15, 2023 (IT) 102023000012294

(51) Int. Cl. B01F 27/072; B01F 27/1121; B01F 27/70; B01F 35/31; B01F 35/32

(52) U.S. Cl. CPC B01F 27/0724; B01F 27/1121; B01F 27/70; B01F 35/31; B01F 35/3204

(57) ABSTRACT

The present invention relates to a high-speed continuous mixing apparatus comprising: a motor stage (3), an intermediate stage (4) and a final stage (5) arranged in alignment with each other; a mixing chamber (25) in the final stage (5); a mixing shaft (7) rotating with respect to the mixing chamber (25) and provided with radial pins (9); an electric motor (6) in the motor stage (3) for driving the mixing shaft (7) in rotation; a coupling joint or fitting (27) between the electric motor (6) and the mixing shaft (7) in the intermediate stage and a pair of rolling bearings (2, 21) for the support of said mixing shaft (7) in said intermediate stage (4). This configuration allows a direct coupling between motor and mixing shaft without using an intermediate reducer.

### CROSS-REFERENCE TO RELATED APPLICATION

The present application claims priority to Italian Patent Application No. 102023000012294, filed Jun. 15, 2023, the entirety of which is incorporated herein by reference.

### FIELD OF APPLICATION

The present invention relates to a high-speed continuous mixing apparatus having an improved structure.

More particularly, the invention relates to a high-speed continuous mixing apparatus comprising at least:
one motor stage, one intermediate stage and one final stage arranged in alignment with each other;
one mixing chamber in said final stage;
one mixing shaft rotating with respect to the mixing chamber and provided with radial pins;
one electric motor in the motor stage for driving said mixing shaft in rotation;
one coupling between said electric motor and said shaft in said intermediate stage.

### PRIOR ART

As it is known in this specific technical field, there are many industrial processes in which mixing and intimate homogenization of solid or solid and liquid components are required, with liquids of different viscosities.

Typically, according to the prior art, in order to achieve this objective, a mixing apparatus is used which includes at least one mixing chamber in which the aforementioned process is implemented by means of a unidirectional rotating mixing shaft that is provided with a plurality of radial pins or blades, for instance as described in patent application n. EP-A-0947540.

A fixed speed device for liquifying chocolate masses according to the prior art is shown in GB 788, 757.

Alternatively, it is also possible to consider the use of an inverted structure with a rotating jacket chamber or drum and a fixed mixing shaft.

The mechanical mixing created by the centrifugal rotation allows the complete mixing and homogenization of both solid products and solid and liquid products, without damaging the microparticles, given that this process does not transmit stresses and frictions which are instead caused by other existing mixing principles.

There are different types of mixers on the market having these basic features and which mainly differ in the number and arrangement of the radial pins of the mixing shaft; however, the different mixing processes require said shaft to be driven at variable speeds.

Typically, this feature is achieved by means of a connecting gearmotor which is inserted between the shaft of the motor stage and the mixing shaft.

Though advantageous under various aspects, this technical solution has some reliability and cost drawbacks.

Moreover, there is a problem represented by the need of subjecting the mechanical coupling represented by the gearmotor to regular maintenance.

An object of the present invention is to simplify the structure of the industrial use apparatuses intended for the continuous mixing of solid or liquid products.

Another object of the invention is to reduce the overall cost of these apparatuses without penalizing their reliability.

A further object is to conceive a continuous mixing apparatus having an improved structure such as to ensure a variable-speed regulation of the mixing shaft of the apparatus, though simplifying the coupling structure between motor stage and mixing final stage.

### SUMMARY OF THE INVENTION

These and other objects of the present disclosure are achieved by a continuous mixing apparatus of the previously indicated type and comprising:
a motor stage, an intermediate stage and a final stage arranged in alignment with each other;
a mixing chamber in said final stage;
a mixing shaft rotating with respect to the mixing chamber and provided with radial pins;
an electric motor in the motor stage for driving said mixing shaft into rotation;
a coupling between said electric motor and said shaft in said intermediate stage and characterized by comprising a coupling joint or fitting between an outer end of a rotation shaft of the motor with a proximal end of said mixing shaft, as well as a pair of rolling bearings for the support of said mixing shaft.

Advantageously, the above coupling fitting connects an outer end of a rotation shaft of the motor with a proximal end of said mixing shaft.

Fixing means to constrain said fitting to the respective ends of said shafts are provided.

Moreover, the motor stage comprises a three-phase electric motor powered by AC alternating current and equipped with a respective programmable inverter.

Actually, the rotational coupling between the shaft of the motor and the mixing shaft is a direct coupling and the speed regulation of the motor and of the mixing shaft is carried out by the inverter of the motor unit.

Moreover, advantageously, within the connecting intermediate stage the diameter of the mixing shaft is greater than the diameter of the same shaft which passes through the mixing chamber.

More particularly, in the final stage and on the side of said intermediate stage there is provided a pre-chamber communicating with the mixing chamber and this pre-chamber is equipped with at least one opening for feeding the first products to be mixed.

It should then be noted that in the mixing shaft multiple pins extending radially and arranged in a spiral are provided and constrained to form a variable configuration, i.e. variable in length, pitch, and division number; the number of pins in the pre-chamber is lower than the number of pins of the mixing chamber.

Finally, the mixing shaft is cantilevered on only one side inside the final stage by means of a support hub provided at a single proximal end of the pre-chamber; the hub being a component of the connecting intermediate stage. In this case, the above pair of rolling bearings for the support of said mixing shaft is located in said intermediate stage upstream of said mixing shaft.

Instead, in case of a long mixing shaft, the two bearings are located on opposite sides of the mixing shaft.

The features and advantages of the continuous mixing apparatus according to the invention will become apparent from the following description of an embodiment thereof given by way of non-limiting example with reference to the appended drawings.

### BRIEF DESCRIPTION OF THE DRAWINGS

FIG. 1 shows a perspective and schematic view of the continuous mixing apparatus according to the present invention;

FIG. 2 shows a top schematic view of the mixing apparatus of FIG. 1;

FIG. 3 shows a longitudinal sectional view of the apparatus of FIG. 1 taken along the section line A-A;

FIGS. 4 and 5 show respective cross-sectional schematic views of a portion of the mixing chamber of the apparatus of FIG. 1 in two different adoptable configurations;

FIG. 6 shows a longitudinal sectional schematic view of the continuous mixing apparatus according to the present invention in an embodiment thereof;

FIG. 7 shows a partial sectional view of an enlarged detail of a stage of the mixing apparatus of FIG. 6.

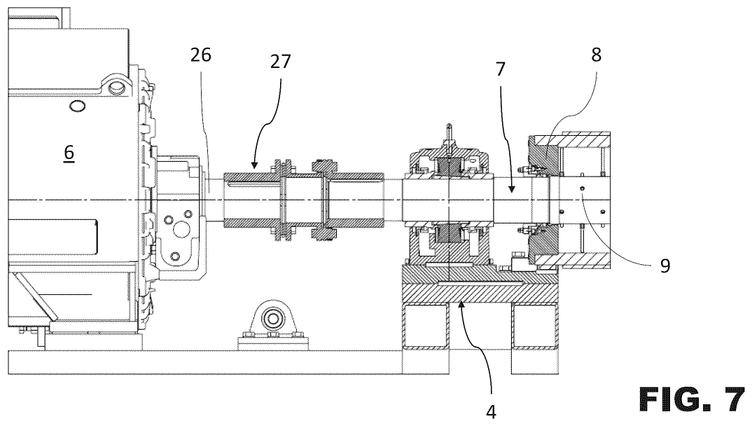

### DETAILED DESCRIPTION

With reference to the appended Figures, reference number 1 globally and schematically indicates a continuous mixing apparatus made according to the present invention.

The apparatus 1 is a high-speed mixer that allows performing an intimate mixing and homogenization industrial process between solid or solid and liquid components, even with liquids of different viscosity.

The apparatus 1 may be defined as a turbo-mixer due to the turbulent action which the mixture of solid or solid and liquid components to be treated is subjected to therein. In the following description this term will also be used to define the apparatus 1 according to the present invention.

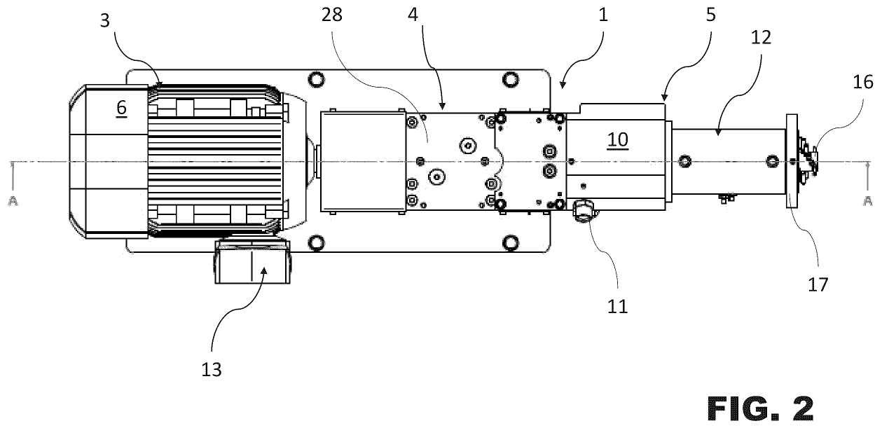

The turbo-mixer 1 herein described in indicative and non-limiting form has a multiple-stage composite structure and, referring to the embodiment illustrated in the top view of FIG. 2, mainly comprises a motor stage 3, a connection stage 4, and a mixing final stage 5.

The first and second stages 3 and 4 are supported on a base 20 by means of dampened spacers 18.

Instead, the mixing final stage 5 is equipped with an own fixed support 22 that is structurally independent with respect to the base 20. These constructive aspects are secondary with respect to the innovation contained in the turbo-mixer 1 according to the invention, but they are described herein for the sake of completeness of description.

The stages 3, 4 and 5 are arranged in substantial axial alignment with each other.

The motor stage 3 comprises a three-phase electric motor 6 powered by AC alternating current and equipped with a respective programmable, regulation and control inverter 13. The motor 6 may indicatively comprise a number of windings equal to six, namely six poles, controlled by the inverter 13.

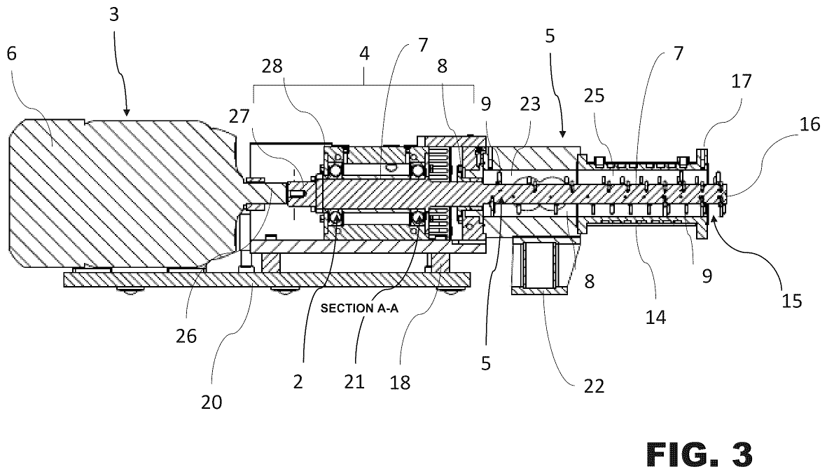

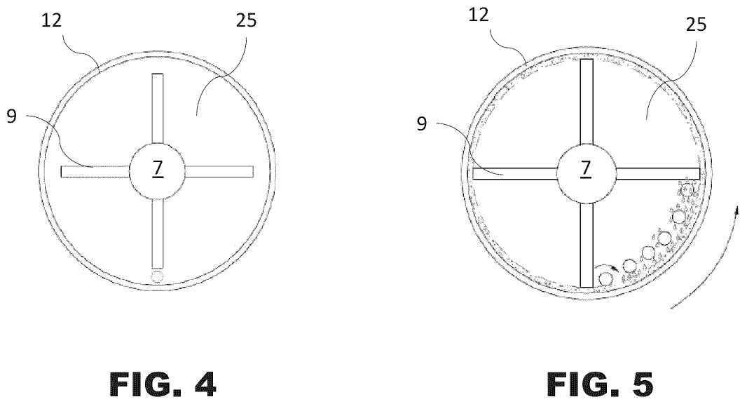

The connection stage 4 is an intermediate stage and includes some aspects of the innovation herein described by way of non-limiting example and will be hereinafter described in greater detail with reference to FIGS. 3 and 4.

The mixing final stage 5 comprises a pre-chamber portion 10 and a mixing chamber 25 configured with a tubular body 12 extended horizontally and longitudinally.

The pre-chamber portion 10 is provided to feed the mixing final stage 5 through a first inlet opening 11 through which first mixing components may be introduced.

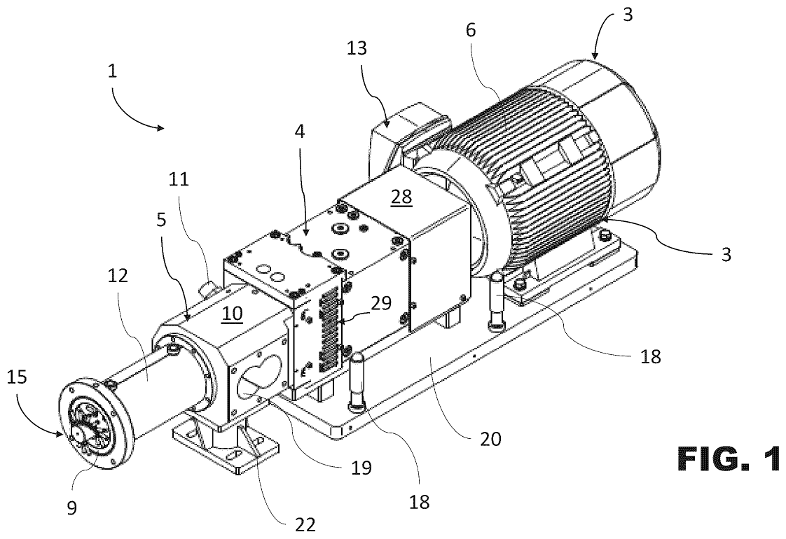

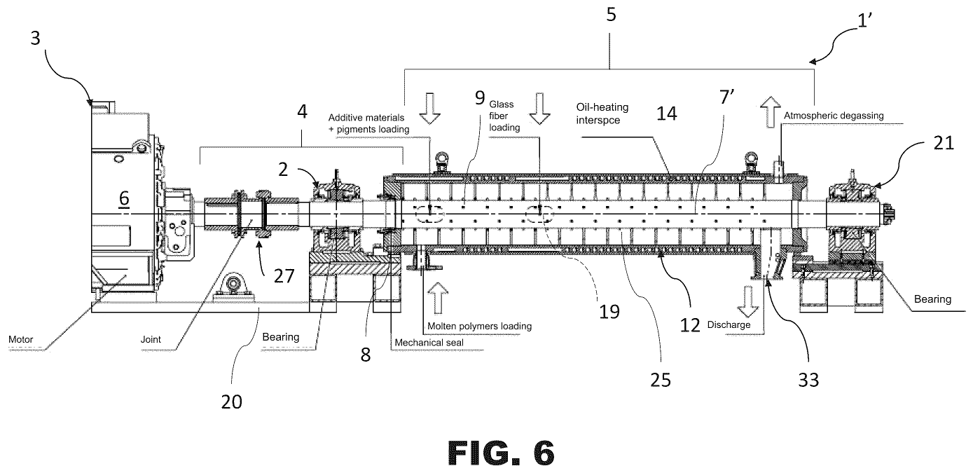

At least one side opening 19, oval in shape (as shown in FIG. 6) or eight-shaped (as in FIG. 1) is also provided, in the first case to allow the connection with a single-screw power supply or in the second case to be connected with a twin-screw power supply, to allow inserting packing and/or very voluminous powders or mixing or pre-mixed products.

The pre-chamber portion 10 is in direct communication with the mixing chamber 25 and comprises a space 23 therein whose shape corresponds to that of the tubular body 12.

The tubular body 12 preferably has an elongated cylindrical shape and is arranged on a longitudinal horizontal axis. However, nothing prevents said tubular body 12 from being shaped with a non-strictly circular section.

Said tubular body 12 is coaxially equipped with a heating jacket or interspace 14 in the internal wall thereof (visible in FIG. 3) intended to be passed through by a diathermic fluid (for instance oil) or by a fluid of different type, to maintain the internal wall of said body 12 at a prefixed temperature according to specific needs of the mixing process.

Actually, the tubular body 12 is the final stage of the turbo-mixer apparatus 1 and has a free end 15 that is open to allow discharging the mixed product.

Inside the tubular body 12 and coaxially thereto a mixing shaft 7 rotating with respect to the mixing chamber 25 is provided.

On the shaft 7 multiple pins 9 extending radially and arranged in a spiral are provided and constrained to form a variable configuration, namely variable in length, pitch, and division number.

For instance, the shaft 7 portion inside the space 23 of the pre-chamber 10 comprises a number of pins that is lower than that of the shaft 7 portion contained in the tubular body 12.

Moreover, based on the needs of the production process, the projection of the pins 9 constrained to the shaft 7 may be different, meaning that some pins may be extended until their free end is grazing the internal wall of the tubular body, or they may be extended until they leave a pre-fixed space between the end of the pin 9 and said internal wall, this space may vary by a few millimeters, until it is reduced for instance to approximately, or at least, 0.5 mm.

This particularity is visible in FIGS. 4 and 5, which show respective schematic sectional views in which, in the case of mixing powders and liquids, the port between pin 9 and internal surface of the mixing chamber 25 of just 0.5 mm, allows forming a very thick and tangential layer of mixed product.

Instead, in the case of mixing granules with powders or liquids, as in the example of FIG. 5, the port between a pin 9 and the internal wall of the chamber 25 is greater than the diameter of the granules. In this way the pin 9 keeps the chamber always clean.

The mixing shaft 7 is cantilevered on only one side inside the chamber 25 of the tubular body 12 and has a free end 16 emerging and projecting beyond the open free end 15 of the tubular body 12 to allow the axial discharge of the mixed product.

More particularly, the mixing shaft 7 is supported by a support hub 8 provided at a single proximal end of the chamber 25.

The hub 8 may be considered as a connection monobloc component of the intermediate stage 4 which is interposed between the motor stage 3 and the mixing final stage 5.

Alternatively, however, as shown in the embodiment of FIG. 6, the mixing shaft 7 may be supported at its opposite ends adopting a solution in which the discharge of the mixed product occurs radially through a discharge opening 33 located in the distal portion of the final stage 5 of the mixer.

In the variant of FIG. 6, the continuous mixing apparatus of the present invention is indicated with reference number 1′, but particulars and cooperating parts having the same structure and operation as the previous embodiment of FIG. 1 will be indicated with the same reference numbers.

The variant of FIG. 6 may be identified as a long shaft configuration 7′ with several inlets for liquids and solids, with respect to the first embodiment.

In this variant it would be possible to also provide for the use of an electric motor with a greater number of windings, for instance eight, i.e. eight pins, still controlled by the inverter 13.

Compared to the previous embodiment, it may be necessary to run even at low rpm, for instance 100÷600 rpm, to avoid overheating of the mixed product especially when treating temperature sensitive polymers.

Advantageously, both for the example of FIG. 1, and for the example of FIG. 6, unlike the solutions proposed by the prior art which provides for a gearmotor as intermediate stage, the intermediate stage 4 of the present invention is mainly configured with a coupling joint or fitting 27, to connect the mixing shaft 7 to the electric motor, and with a pair of rolling bearings 2, 21 of the mixing shaft 7.

In the embodiment of FIG. 1 the pair of rolling bearings 2 and 21 is located in the intermediate stage 4 upstream of the mixing shaft 7 and before the hub 8.

A box-shaped casing 28 encloses these components 27, 2 and 21 of the intermediate stage 4 and also comprises a grid portion 29 for cooling the internal components. Said grid portion 29 is provided on a side surface of the casing 28 at an interspace between the second bearing 21 and the hub 8.

Instead, in the variant of FIG. 6 the two rolling bearings 2 and 21 for supporting the mixing shaft 7 are located on opposite sides of the mixing shaft 7, with the first bearing 2 belonging to the intermediate stage 4 and the second bearing 21 located at the distal end of the final stage 5.

In both embodiments the coupling between the electric motor 6 and the mixing shaft 7 directly occurs through the joint 27 without using an intermediate gearmotor.

More particularly, the electric motor 6 has an own rotation shaft 26 that has an outer end connected to a proximal end of the mixing shaft 7 by means of the coupling joint or fitting 27, structured for instance as a double coaxial sleeve, as shown in FIG. 4.

The fitting element 27 may have two housing sleeve portions or seats of different diameter to couple on one side with the outer or free end of the rotation shaft 26 of the motor 6 and on the other side with the proximal end of the mixing shaft 7.

Conventional means are provided for fixing and constraining the connection element 27 to the respective shafts.

Basically, the rotational coupling between the shaft of the motor 6 and the mixing shaft 7 is a direct coupling through the joint 27, and the speed regulation of the motor and of the mixing shaft is carried out through the inverter 13 of the motor unit 3 without using an intermediate gearmotor. This has the great advantage of reducing the overall consumption of the apparatus since the gearbox used in prior art solutions typically absorbs 25%-35% of the motor's energy.

Inside the connection intermediate stage 4 the diameter of the mixing shaft 7 may be greater than the diameter of the same shaft 7 which passes through the pre-chamber portion 10 and the mixing chamber 25.

More particularly, a section of the mixing shaft 7 extended inside the intermediate stage 4 between the two rolling bearings 2 and 21 has a diameter greater than a further section of the mixing shaft 7 comprised between the second bearing 21 and the support hub 8.

Downstream of the support hub 8, in the mixing and discharging direction of the mixed products, a further reduction in the diameter of the mixing shaft 7 can be noted.

This change in diameter is intended to give greater strength to the shaft 7 in the shaft portion intended for the rolling support, i.e. the one located between the two bearings 2 and 21.

As said, the electric motor 6 that drives the motor shaft 7 of the continuous mixing apparats 1 in rotation is a three-phase motor.

The speed of the motor 6 does not depend on the voltage supplied to the ends of its windings, as in the universal motors, but rather on the frequency of the electrical distribution network.

Advantageously, according to the invention, the action of the three-phase inverter 13 is such that the interconnections between the windings of the motor 6 can be modified dynamically during its operation, for instance from a star type connection to a delta type connection.

For instance, by initially opting for a star configuration, it is possible to reduce the absorption of high currents during the starting phase to allow overcoming a predetermined starting load.

Subsequently, the configuration of the windings may be automatically and dynamically switched by the inverter 13 into a delta configuration so that the steady-state currents can increase on the windings of the motor 6 and thus increase the efficiency of the motor itself.

Moreover, the inverter 13 is of the programmable type so as to regulate the acceleration or deceleration of the motor 6 by acting dynamically on the waveforms of the supply current, thus developing a predetermined torque and managing the number of revolutions of the motor 6, even at speeds above 9000 rpm.

The operation of the continuous mixing apparatus according to the invention is particularly useful in many industrial fields: pharmaceutical, food, chemical, plastic or others, which require the mixing and homogenization of solid or solid and liquid components, or even pasty products at room temperature, or preheated or cooled at the desired temperature.

More particularly, the solution illustrated in FIG. 6 can be used as a compounder for thermoplastic products with diathermic oil heating for temperatures up to 300° C. and with electrical resistances for temperatures above 300° C. In this way, better homogenization and dispersion is ensured compared to the current single-screw and twin-screw extruders in the field of thermoplastic materials, while ensuring energy savings equal to 30-40%.

The particular conformation of the mixing shaft with pins arranged in a helical manner allows for the formation of a very thin layer of mixed product which even allows the homogenization of non-miscible products with different particle sizes, viscosities, and specific weights. In fact, during the centrifuge phase the product is only contacted by the tip of the pin.

Furthermore, the tangential surface of the product with a millimeter film thickness allows excellent heat exchange, thus avoiding thermal stratification.

By turning at high speed, the pins create currents and turbulences which facilitate the mixing of the various ingredients without creating mechanical friction.

Advantageously, the mixer according to the invention can be installed in the production processes individually or in cascade.

According to the invention, the rotating mixing shaft 7 works at a high rotation speed and therefore the high mixing speed reduces the mixing times and consequently the residence times of the products inside the mixer. Indeed, this allows reducing the volumes of the mixing chambers.

1. A high-speed continuous mixing apparatus comprising:
a motor stage, an intermediate stage and a final stage arranged in alignment with each other;
a mixing chamber in said final stage;
a mixing shaft rotating with respect to the mixing chamber and provided with radial pins;
an electric motor in the motor stage for driving said mixing shaft in rotation;
a coupling between said electric motor and said shaft in said intermediate stage;
a coupling joint or fitting between an outer end of a rotation shaft of the motor with a proximal end of said mixing shaft;
a pair of rolling bearings for the support of said mixing shaft;
said motor stage further comprising:
a three-phase electric motor powered by AC alternating current and equipped with a respective programmable inverter;
wherein the rotational coupling between the motor shaft and the mixing shaft is a direct coupling and the speed regulation of the motor and the mixing shaft is carried out by the inverter of the motor unit without using a gearmotor.

2. The high speed continuous mixing apparatus according to claim 1, wherein said pair of rolling bearings for supporting said mixing shaft is located in said intermediate stage upstream of said mixing shaft.

3. The high speed continuous mixing apparatus according to claim 1, wherein said pair of rolling bearings for supporting said mixing shaft is situated on opposite sides of the mixing shaft.

4. The high speed continuous mixing apparatus according to claim 1, wherein, inside the intermediate stage, the diameter of the mixing shaft is greater than the diameter of the same shaft which passes through said mixing chamber.

5. The high speed continuous mixing apparatus according to claim 1, wherein in said final stage, on the side of said intermediate stage, a pre-chamber is provided communicating with said mixing chamber and equipped with at least one opening for feeding the first products to be mixed.

6. The high speed continuous mixing apparatus according to claim 5, wherein on the mixing shaft multiple pins extending radially and arranged in a spiral are provided and constrained to form a variable configuration, i.e. variable in length, pitch, and division number, and that the number of pins in said prechamber is lower than the number of pins in the mixing chamber.

7. The high speed continuous mixing device according to claim 5, wherein the mixing shaft is cantilevered on one side only inside the final stage by means of a support hub provided at a single proximal end of said prechamber; the hub being a component of the intermediate stage.

8. The high speed continuous mixing apparatus according to claim 7, wherein, downstream of the support hub, in the mixing and discharging direction of the mixed products, a reduction in the diameter of the mixing shaft is provided.
